(19) United States
(12) Patent Application Publication
(10) Pub. No.: US 2012/0059528 A1
(43) Pub. Date: Mar. 8, 2012

(54) SERVER, CHARGING SERVER, POWER CONSUMPTION CALCULATING SYSTEM, AND COMPUTER PROGRAM PRODUCT

(75) Inventors: Kentaro UMESAWA, Kanagawa (JP); Yuichi KOMANO, Kanagawa (JP); Shinji YAMANAKA, Tokyo (JP); Toshinari TAKAHASHI, Tokyo (JP)

(73) Assignee: KABUSHIKI KAISHA TOSHIBA, Tokyo (JP)

(21) Appl. No.: 13/164,857

(22) Filed: Jun. 21, 2011

(30) Foreign Application Priority Data
Sep. 8, 2010 (JP) 2010-201318

(51) Int. Cl. G06F 1/28; G06F 19/00

(52) U.S. Cl. 700/295; 700/297; 702/62

(57) ABSTRACT

According to an embodiment, a server to which a plurality of power meters each measuring an amount of power consumption of an electric appliance is connected, includes a receiving unit, a first storage unit and a calculating unit. The receiving unit receives a calculation result. The calculation result is calculated based on the amount of power consumption measured by each of the plurality of power meters and each of random numbers generated according to a probability distribution by each of the plurality of power meters. The first storage unit stores therein parameters for generating random numbers. The calculating unit calculates an estimation value of a sum or average of the amounts of power consumption using the calculation results and the parameters. The estimation value is used for determining whether to perform power control.

### CROSS-REFERENCE TO RELATED APPLICATION(S)

This application is based upon and claims the benefit of priority from Japanese Patent Application No. 2010-201318, filed on Sep. 8, 2010; the entire contents of which are incorporated herein by reference.

### FIELD

Embodiments described herein relate generally to a server, a charging server, a power consumption calculating system, and a computer program product.

### BACKGROUND

A next-generation power grid (smart grid) has been constructed in order to stabilize the quality of power when renewable energy, such as wind or solar power, is used in addition to conventional power, such as nuclear power or thermal power. In the next-generation power grid, a smart meter (referred to as an SM) that measures the amount of power consumption and a home server that manages electric appliances are installed in each home or each office. The SM communicates with a meter data management system (MDMS) through the power grid. The MDMS receives the amount of power consumption from the SM in each home or each office at a predetermined time interval and stores it. An energy management system (EMS) performs power control, such as a process of requesting the SM or the home server in each home or each office to cut down power use or a process of controlling the charge or discharge of a rechargeable battery connected to the power grid, on the basis of the amounts of power consumption of a plurality of homes or offices which is gathered by the MDMS.

Meanwhile, for example, there is an energy management system as an application server that is connected to the power grid and executes various kinds of applications. The server controls the power grid on the basis of the amount of power consumption of each home or office which is gathered by the MDMS. When receiving a request to read the amount of power consumption from the SM, the MDMS discloses the information stored therein. Therefore, it is considered that the MDMS stores the amount of power consumption of each home or office. However, the administrator of the storage server of the MDMS or an unauthorized user who illegally accesses the storage server sees the amount of power consumption of each home to thereby guess whether the consumer is in the home or office and the consumer's activities, which results in an invasion of privacy.

### BRIEF DESCRIPTION OF THE DRAWINGS

FIG. 1 is a diagram illustrating an example of the structure of a power consumption calculating system according to an embodiment;

FIG. 2 is a diagram illustrating an example of the functional structure of an SM 102a;

FIG. 3 is a diagram illustrating an example of the functional structure of a home server 102b;

FIG. 4 is a diagram illustrating an example of the functional structure of an MDMS 101;

FIG. 5 is a diagram illustrating an example of the functional structure of an EMS 103;

FIG. 6 is a diagram illustrating an example of the functional structure of a charging server 104;

FIG. 7 is a flowchart illustrating the procedure of a total power consumption calculating process;

FIG. 8 is a flowchart illustrating the procedure of a charging system process;

FIG. 9 is a flowchart illustrating the procedure of a reading request process;

FIG. 10 is a diagram illustrating an example of the functional structure of an SM 102a according to a modification;

FIG. 11 is a diagram illustrating an example of the functional structure of an EMS 103;

FIG. 12 is a flowchart illustrating the procedure of a process of generating a new random number generation parameter;

FIG. 13 is a diagram illustrating an example of the functional structure of an SM 102a according to a modification;

FIG. 14 is a diagram illustrating an example of the functional structure of an MDMS 101; and

FIG. 15 is a diagram illustrating an example of the functional structure of a charging server 104.

### DETAILED DESCRIPTION

According to an embodiment, a server to which a plurality of power meters each measuring an amount of power consumption of an electric appliance is connected, includes a receiving unit, a first storage unit and a calculating unit. The receiving unit receives a calculation result. The calculation result is calculated based on the amount of power consumption measured by each of the plurality of power meters and each of random numbers generated according to a probability distribution by each of the plurality of power meters. The first storage unit stores therein parameters for generating random numbers. The calculating unit calculates an estimation value of a sum or average of the amounts of power consumption using the calculation results and the parameters. The estimation value is used for determining whether to perform power control.

Various embodiments will be described hereinafter with reference to the accompanying drawings.

First, the outline of a power consumption calculating system according to an embodiment will be described. The power consumption calculating system includes an MDMS connected to the SM. The SM performs a perturbation process for perturbating the amount of power consumption, which is measured by the SM, in order to protect privacy using random numbers generated from a probability distribution according to random number parameters stored therein. Specifically, for example, the SM adds the random number to the amount of power consumption to perturbate the amount of power consumption. Then, the SM transmits the perturbated amount of power consumption (referred to as perturbated power consumption) to the MDMS. The MDMS stores therein the received perturbated power consumption and transmits it to an energy management system and a charging server. The energy management system receives the perturbated power consumption, cancels perturbation from the perturbated power consumption to calculate an estimation value of a sum of amounts of power consumption, and controls the supply of power in the power grid on the basis of the estimation value. The power control is a process that is indirectly related to future energy control, for example, a process of using the data of the current power consumption for mid-to-long-term power demand forecast, such as a process of making a supply and demand plan, or a direct process with readiness that adjusts the supply of power from a rechargeable battery such that the demand-supply unbalance between the actual record and plan of power supply is corrected or requests the consumer to control the power use. The charging server receives the perturbated power consumption, calculates a sum of amounts of actual power consumption from the perturbated power consumption, and performs a charging process using the sum of amounts of the actual power consumption. As such, the SM performs the perturbation process for protecting privacy. However, in some cases, the estimation value of the sum of amounts of power consumption or the sum of amounts of the actual power consumption, not the perturbated power consumption, is needed.

Privacy information identifies the preference or action of an individual or a group. The privacy information also includes information identifying an individual or a group. In addition, even when an individual or a group is not identified, the privacy information can include information indicating the tendency of the preference or action of an individual or a group. It may be determined in advance or dynamically whether the amount of power consumed during a unit time concerns the privacy information. In addition, even when the amount of power consumed during the unit time or a place where power is consumed does not concerns the privacy information, the perturbation process may be performed or information may be stored in the MDMS, as described above.

In the following embodiments, an example in which an EMS that receives, as an input, a sum (referred to as a first total perturbated power consumption) of perturbated amounts of power consumption of a plurality of homes consumed in a first unit time and a charging server that receives, as an input, a sum (referred to as a second total perturbated power consumption) of perturbated amounts of power consumption of each home consumed in a second unit time are used as application servers will be described. The first unit time means a time interval during which the EMS controls a power grid using the total power consumption and is, for example, a time interval of 30 minutes. The second unit time basically means a time interval during which the charging server performs a charging process and is generally one month. When the power rate needs to be calculated during the month due to, for example, a move, the second unit time is a period from the month after the month corresponding to the previous charging process to the time when the use of power stops. In the following embodiments, the amount of power consumption of each home is concealed, but the amount of power consumption within the measurement range (measurement unit) of the smart meter using power, not the amount of power consumption of each home, may be concealed. In this case, in this disclosure, the “home” may be replaced with the “measurement range (measurement unit)”.

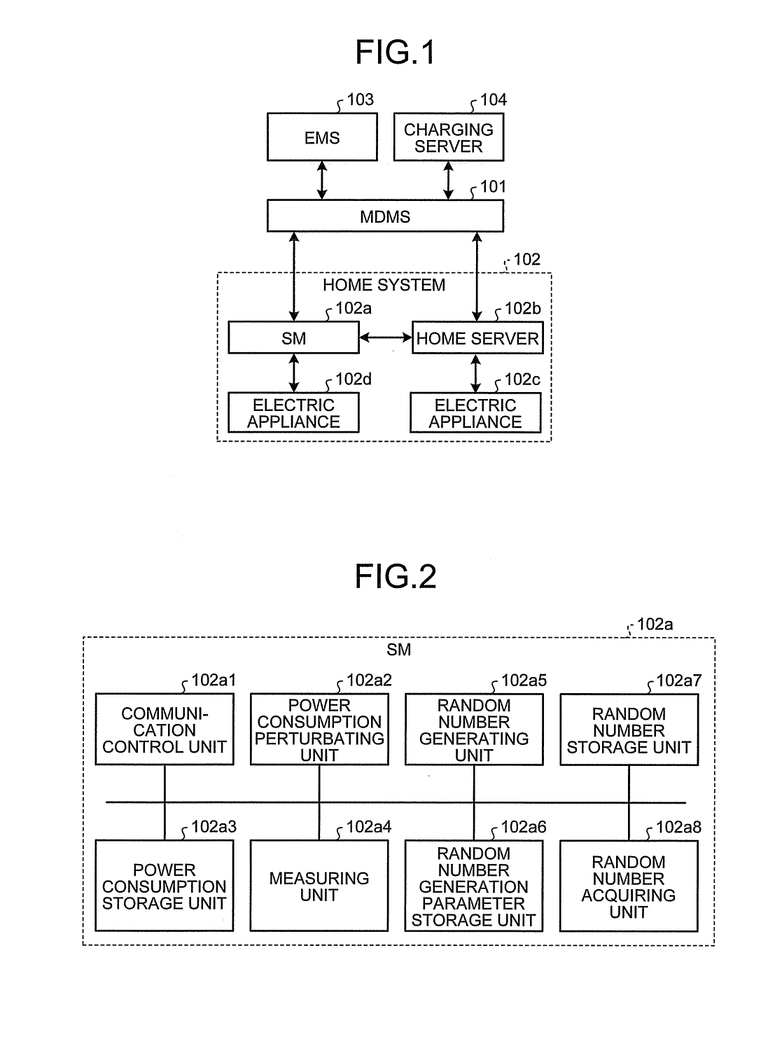

FIG. 1 is a diagram illustrating an example of the structure of a power consumption calculating system according to this embodiment. As shown in FIG. 1, the power consumption calculating system includes a meter data management system (MDMS) 101, a home system 102, an energy management system (EMS) 103, and a charging server 104 which are connected to one another through, for example, a network. For simplicity of illustration, one home system 102 is shown; however, the plurality of home systems 102 may be connected to the power consumption calculating system. The network is, for example, a Local Area Network (LAN), an intranet, Ethernet (registered trademark), or the Internet. The MDMS 101 gathers and manages the amount of power consumption of each home through, for example, the network. The home system 102 is provided in the home, measures the amount of power consumption of home electric appliances, and includes a smart meter (SM) 102a, a home server 102b, an electric appliance 102c, and an electric appliance 102d. The electric appliance 102c is connected to the home server 102b by wire or wirelessly. The home server 102b manages the amount of power consumption of the electric appliance 102c and controls the electric appliance 102c. The electric appliance 102d is connected to the SM 102a by wire or wirelessly. The SM 102a acquires the amount of power consumption of the electric appliance 102c through the home server 102b and adds the amount of power consumption of the electric appliance 102c to the amount of power consumption of the electric appliance 102d to measure the amount of power consumption of the home system 102.

Identification information (referred to as home identification information) for identifying the home system 102 is given to the home system 102, and it is assumed that the home server 102b and the SM 102a store the home identification information given to the home system 102. Furthermore, it is assumed that each of the MDMS 101, the EMS 103, and the charging server 104 stores all of the home identification information of each home system 102 connected to the power consumption calculating system.

Next, the hardware structure of the MDMS 101, the SM 102a, the home server 102b, the EMS 103, and the charging server 104 will be described. It is assumed that the EMS 103 and the MDMS 101 are servers, similar to the charging server 104. The MDMS 101, the EMS 103, and the charging server 104 each include a control unit, such as a Central Processing Unit (CPU) that controls the overall operation of the apparatus or executes a basic operation, a main storage unit, such as a Read Only Memory (ROM) or a Random Access Memory (RAM) that stores various kinds of data or various kinds of programs, an auxiliary storage unit, such as an Hard Disk Drive (HDD) or a Compact Disk (CD) drive device that stores various kinds of data or various kinds of programs, and a bus that connects these components, and has a hardware structure using a general computer. In addition, the MDMS 101 and the EMS 103 further include a communication Interface (I/F) that performs communication through, for example, a network. The SM 102a and the home server 102b include a control unit, such as a CPU that controls the overall operation of the apparatus, a main storage unit, such as a ROM or a RAM that stores various kinds of data or various kinds of programs, an auxiliary storage unit, such as a non-volatile memory that stores various kinds of data or various, kinds of programs, a communication I/F that communicates with an external apparatus, and a bus that connects these components, and has the same structure as dedicated hardware or an embedded apparatus. The SM 102a and the home server 102b further include a communication I/F that performs communication through, for example, a network. In addition, the home server 102b is connected to a display unit that displays various kinds of information, such as the amount of power consumed, and an operation input unit, such as an operation button or a keyboard used by the user to input information.

Next, in the hardware structure, functions implemented by each of the MDMS 101, the SM 102a, the home server 102b, the EMS 103, and the charging server 104 will be described. First, functions implemented by the SM 102a will be described. FIG. 2 is a diagram illustrating an example of the functional structure of the SM 102a. The SM 102a includes a communication control unit 102a1, a power consumption perturbating unit 102a2, a power consumption storage unit 102a3, a measuring unit 102a4, a random number generating unit 102a5, a random number generation parameter storage unit 102a6, a random number storage unit 102a7, and a random number acquiring unit 102a8. The function of the communication control unit 102a1 is implemented by the communication I/F of the SM 102a and the execution of various kinds of programs stored in the main storage unit or the auxiliary storage unit by the CPU of the SM 102a. The CPU of the SM 102a executes various kinds of programs stored in the main storage unit or the auxiliary storage unit to implement the functions of the power consumption perturbating unit 102a2, the measuring unit 102a4, the random number generating unit 102a5, and the random number acquiring unit 102a8. The power consumption storage unit 102a3, the random number generation parameter storage unit 102a6, and the random number storage unit 102a7 are storage areas that are ensured in, for example, the auxiliary storage unit of the SM 102a.

The communication control unit 102a1 controls the communication of, for example, the home server 102b or the MDMS 101 with other apparatuses. In particular, the communication control unit 102a1 transmits the perturbated power consumption calculated by the power consumption perturbating unit 102a2, which will be described below, to the MDMS 101, receives a random number request command from the home server 102b, which will be described below, transmits a sum of random numbers calculated by the random number acquiring unit 102a8, which will be described below, to the home server 102b in response to the random number request command, receives a random number request command from the charging server 104, which will be described below, or transmits the sum of random numbers calculated by the random number acquiring unit 102a8, which will be described below, to the charging server 104 in response to the random number request command.

The measuring unit 102a4 mechanically calculates an amount of power consumption z_{i, j} of the electric appliances 102c and 102d every first unit time. The measuring unit 102a4 stores the calculated amount of power consumption in the power consumption storage unit 102a3. In this case, the measuring unit 102a4 may measure the amount of power consumption of the electric appliances 102c and 102d every first unit time as follows: after authenticating the electric appliance 102d through the communication control unit 102a1, at least once within the first unit time, the measuring unit 102a4 stores the amount of power consumption of the electric appliance 102d in the power consumption storage unit 102a3 and stores the amount of power consumption of the electric appliance 102c managed by the home server 102b, which will be described below, in the power consumption storage unit 102a3. In the amount of power consumption z_{i, j}, i indicates an index corresponding to the home system 102 and j indicates an index corresponding to the sequence (for example, date and time) of the first unit time.

The random number generation parameter storage unit 102a6 stores therein random number generation parameters. The random number generation parameters indicate, for example, the mean or variance of a given probability distribution. The random number generation parameters are used to generate random numbers according to the probability distribution using a well-known algorithm. For example, when uniform random numbers are drawn from a uniform distribution, a Mersenne Twister method may be used. When normal random numbers are drawn from a normal distribution, a Box Muller method may be used. These are calculated using the mean or variance of the probability distribution. For example, the normal random number according to a mean μ and a variance σ2 may be obtained by converting a uniform random number into a normal random number with a mean of 0 and a variance of 1 using the Box Muller method, multiplying the normal random number by σ, and adding the mean μ to it (see Box, G. E. P. and E. Muller: A note on the generation of normal deviates, Ann. math. stat., 29, pp. 610-611, 1958). There is a Mersenne Twister method as a method of generating a uniform random number which is used in the Box Muller method (see Matsumoto, M. and T. Nishimura: “Mersenne Twister,” ACM Transcript on Modeling and Computer Simulation, Vol. 8, No. 1, 1998).

In order to generate a uniform random number, for example, a hardware random number generator, such as a random number generating circuit, may be provided. In this case, it is possible to improve the quality of random numbers. The random number generation parameters are set to values common to a group of the plurality of SMs 102a in the region in which the EMS 103, which will be described below, calculates total power consumption. The random number generation parameters are stored in the random number generation parameter storage unit 102a6 when the SM 102a is manufactured in, for example, a manufacturing line, or the random number generation parameters are set on-line or using a special apparatus during initial start-up, initial setting, or start-up in the maintenance mode.

The random number generating unit 102a5 generates a random number r_{i, j} using the random number generation parameters stored in the random number generation parameter storage unit 102a6. The power consumption perturbating unit 102a2 adds the random number generated by the random number generating unit 102a5 to the amount of power consumption stored in the power consumption storage unit 102a3 and, as a result, perturbates the amount of power consumption. Then, the power consumption perturbating unit 102a2 stores the perturbated amount of power consumption (perturbated power consumption) in the power consumption storage unit 102a3. The power consumption storage unit 102a3 stores therein the amount of power consumption calculated by the measuring unit 102a4 or the perturbated power consumption calculated by the power consumption perturbating unit 102a2. The amount of power consumption and the perturbated power consumption are stored so as to be associated with the first unit time. The random number storage unit 102a7 stores therein the random number r_{i, j} generated by the random number generating unit 102a5. The random number r_{i, j} is stored so as to be associated with the first unit time identified by j.

In response to the random number request command received from the home sever 102b, which will be described below, through the communication control unit 102a1, the random number acquiring unit 102a8 acquires, from the random number storage unit 102a7, the random numbers that have been used to perturbate the amounts of power consumption corresponding to the first unit times included in a desired reading period of time designated by the random number request command, adds up the random numbers to calculate a total random number, and transmits the total random number to the home server 102b through the communication control unit 102a1. In response to the random number request command received from the charging server 104, which will be described below, through the communication control unit 102a1, the random number acquiring unit 102a8 acquires, from the random number storage unit 102a7, the random numbers that have been used to perturbate the amounts of power consumption corresponding to the first unit times included in the second unit time designated by the random number request command, adds up the random numbers to calculate a total random number, and transmits the total random number to the charging server 104 through the communication control unit 102a1.

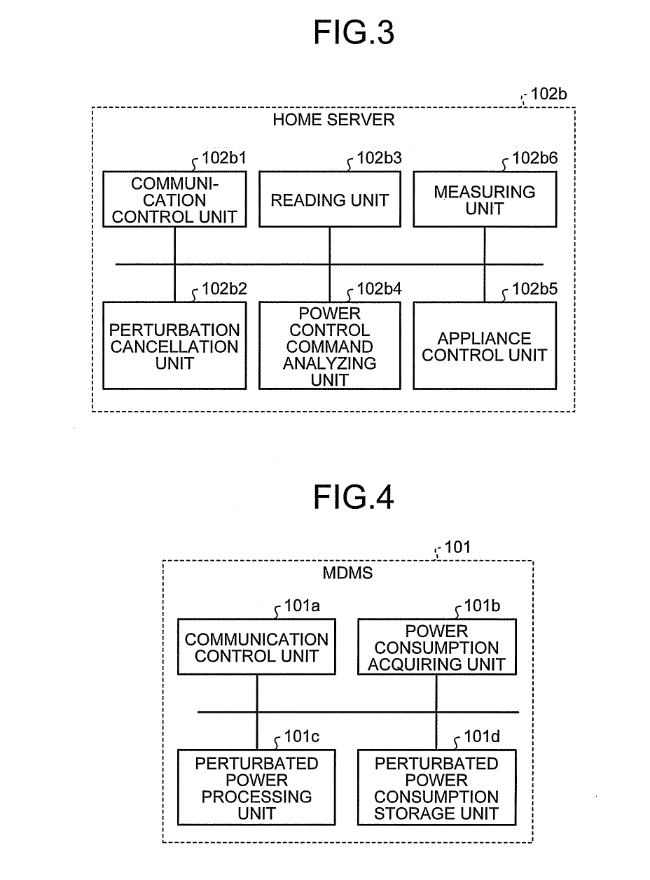

Next, various kinds of functions implemented by the home server 102b will be described. FIG. 3 is a diagram illustrating an example of the functional structure of the home server 102b. The home server 102b includes a communication control unit 102b1, a perturbation cancellation unit 102b2, a reading unit 102b3, a power control command analyzing unit 102b4, an appliance control unit 102b5, and a measuring unit 102b6. The function of the communication control unit 102b1 is implemented by the communication I/F of the home server 102b and the execution of various kinds of programs stored in the main storage unit or the auxiliary storage unit by the CPU of the home server 102b. The CPU of the home server 102b executes various kinds of programs stored in the main storage unit or the auxiliary storage unit to implement the functions of the perturbation cancellation unit 102b2, the reading unit 102b3, the power control command analyzing unit 102b4, the appliance control unit 102b5, and the measuring unit 102b6.

The communication control unit 102b1 controls communication with another apparatus, such as the SM 102a or the MDMS 101. In particular, the communication control unit 102b1 performs the following operations: the communication control unit 102b1 accesses the SM 102a and transmits the amount of power consumption measured by the measuring unit 102b6, which will be described below, to the SM 102a, thereby writing the measured amount of power consumption to the SM 102a; the communication control unit 102b1 transmits the reading request command generated by the reading unit 102b3, which will be described below, to the MDMS 101; the communication control unit 102b1 transmits the random number request command generated by the reading unit 102b3 to the SM 102a; the communication control unit 102b1 receives the perturbated power consumption transmitted from the MDMS 101 in response to the reading request command; the communication control unit 102b1 receives the total random number transmitted from the SM 102a in response to the random number request command; and the communication control unit 102b1 receives the power control command transmitted from the EMS 103 which will be described. The perturbation cancellation unit 102b2 subtracts the random number r_{i, j} from perturbated power consumption rz_{i, j} to cancel perturbation in the perturbation power consumption, thereby calculating the amount of power consumption z_{i, j}, using the perturbated power consumption rz_{i, j} received from the MDMS 101 through the communication control unit 102b1 in response to the reading request command, which will be described below, and the random number r_{i, j} received from the SM 102a through the communication control unit 102b1 in response to the reading request command.

The measuring unit 102b6 measures the amount of power consumption of the electric appliance 102c, accesses the SM 102a through the communication control unit 102b1, and writes the amount of power consumption into the SM 102a. The reading unit 102b3 controls a process of reading the amount of power consumption. For example, this control operation is performed in response to a power consumption reading request input through the operation input unit. In the reading process, first, the reading unit 102b3 generates a reading request command to request the reading of power consumption, transmits the reading request command from the communication control unit 102b1 to the MDMS 101, and receives one or more pieces of data of the perturbated power consumption with respect to the first unit time, in response to the reading request command transmitted from the MDMS 101 through the communication control unit 102a1. A period (referred to as a desired reading period) for which power consumption is desired to be read or a value corresponding to the desired reading period may be predetermined, or alternatively, it may be designated by an operation input by the user through the operation input unit. The reading unit 102b3 generates a reading request command designating the home identification information given to the home system 102 and the desired reading period. In addition, the reading unit 102b3 designates the desired reading time, generates a random number request command to request the transmission of the random numbers that have been used to perturbate power consumption within the desired reading time, and transmits the random number request command from the communication control unit 102b1 to the SM 102a. The reading unit 102b3 controls the perturbation cancellation unit 102b2 to cancel perturbation in the perturbated power consumption using the perturbated power consumption and the random number received from the SM 102a through the communication control unit 102a1 and displays the amount of power consumption calculated by the perturbation cancellation unit 102b2 on a display unit. In this embodiment, during the reading process, the amount of power consumption is displayed on the display unit connected to the home server 102b. However, the amount of power consumption may be displayed on an output terminal (not shown) connected to the home system.

The power control command analyzing unit 102b4 analyzes the content of the power control command received from the EMS 103 through the communication control unit 102b1. When the power control command analyzing unit 102b4 interprets the content of the power control command as meaning that the power control command requests to control the power use and determines to accede to the request, it outputs an appliance power control command to request the control of the power used by the electric appliance 102c connected to the home server 102b to the appliance control unit 102b5. The power control command analyzing unit 102b4 may display a message inquiring of the user whether to accede to the request to control the power use on the display unit, or transmit the message to another apparatus, such as a portable terminal, through the communication control unit 102b1. When the power control command analyzing unit 102b4 outputs the appliance power control command to the electric appliance 102c, the appliance control unit 102b5 controls the power used by the electric appliance 102c in response to the appliance power control command.

Next, various kinds of functions implemented by the MDMS 101 will be described. FIG. 4 is a diagram illustrating an example of the functional structure of the MDMS 101. As shown in FIG. 4, the MDMS 101 includes a communication control unit 101a, a power consumption acquiring unit 101b, a perturbated power processing unit 101c, and a perturbated power consumption storage unit 101d. The function of the communication control unit 101a is implemented by the communication I/F of the MDMS 101 and the execution of various kinds of programs stored in the main storage unit or the auxiliary storage unit by the CPU of the MDMS 101. The functions of the power consumption acquiring unit 101b and the perturbated power processing unit 101c are implemented by the execution of various kinds of programs stored in the main storage unit or the auxiliary storage unit by the CPU of the MDMS 101. The perturbated power consumption storage unit 101d is a storage area that is ensured in, for example, the auxiliary storage unit of the MDMS 101.

The communication control unit 101a controls communication with another apparatus, such as the SM 102a, the EMS 103, the charging server 104, or an application server 105. In particular, the communication control unit 101a receives the perturbated power consumption rz_{i, j} from the SM 102a, receives the reading request command from the home server 102b, transmits the sum of the perturbated power consumption stored in the perturbated power consumption storage unit 101d to the home server 102b in response to the reading request command, transmits the sum (referred to as first total perturbated power consumption) of the perturbated amounts of power consumption of a plurality of home systems 102 in the first unit time, which is calculated by the perturbated power processing unit 101c which will be described below, to the EMS 103, receives a charging process command to perform a charging system process from the charging server 104, or transmits the sum (referred to as second total perturbated power consumption) of the perturbated amounts of power consumption of each home system 102 in the second unit time, which is calculated by the perturbated power processing unit 101c which will be described below, to the charging server 104 in response to the charging process command. The power consumption acquiring unit 101b stores, in the perturbated power consumption storage unit 101d, the perturbated power consumption of each home system 102 for each first unit time which is received from the SM 102a. The perturbated power consumption storage unit 101d stores therein the perturbated power consumption.

The perturbated power processing unit 101c adds up the perturbated power consumption rz_{i, j} of a plurality of home systems 102 within a given region in the first unit time, which is stored in the perturbated power consumption storage unit 101d, so as to calculate the first total perturbated power consumption, which is the sum of the perturbated amounts of power consumption of the plurality of home systems 102 within the region in the first unit time. Then, the perturbated power processing unit 101c transmits the first total perturbated power consumption to the EMS 103 through the communication control unit 101a. The first total perturbated power consumption RZ is calculated by, for example, the following Expression (1):

RZ=Σₘrz_{—}{m, j} (1)

where m indicates an index for each of a plurality of home systems.

The perturbated power processing unit 101c adds up, for each home system 102, the perturbated power consumption rz_{i, j} for a plurality of the first unit times included in the second unit time, which is stored in the perturbated power consumption storage unit 101d, so as to calculate the second total perturbation power consumption, which is the sum of the perturbated amounts of power consumption of the home system 102 in the second unit time. Then, the perturbated power processing unit 101c transmits the second perturbation power consumption to the charging server 104 through the communication control unit 101a. The second total perturbated power consumption RZ′ is calculated by, for example, the following Expression (2):

RZ′=Σₗrz_{—}{i, l} (2)

where l indicates an index for each first unit time.

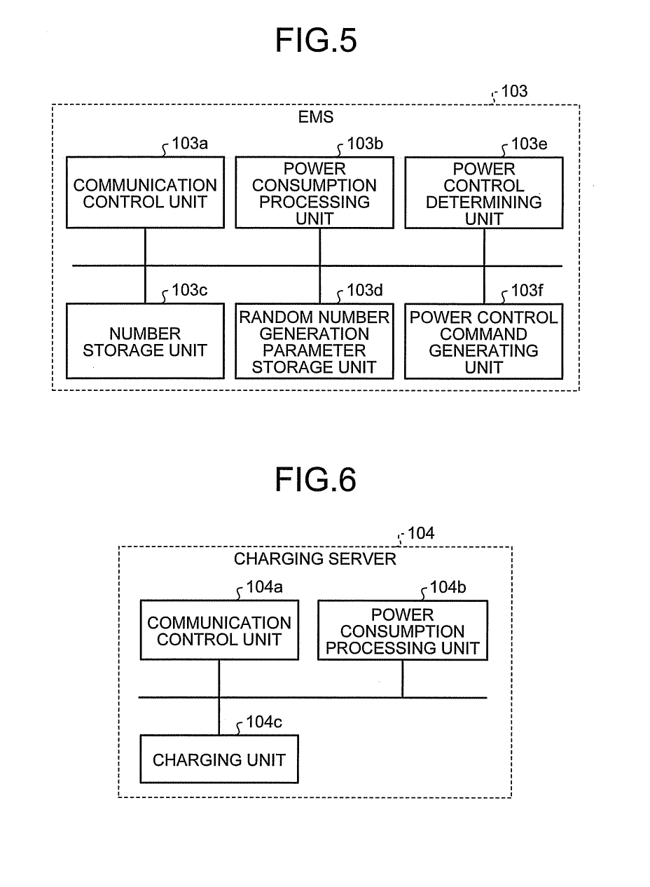

Next, various kinds of functions implemented by the EMS 103 will be described. FIG. 5 is a diagram illustrating an example of the functional structure of the EMS 103. As shown in FIG. 5, the EMS 103 includes a communication control unit 103a, a power consumption processing unit 103b, a number storage unit 103c, a random number generation parameter storage unit 103d, a power control determining unit 103e, and a power control command generating unit 103f. The function of the communication control unit 103a is implemented by the communication I/F of the EMS 103 and the execution of various kinds of programs stored in the main storage unit or the auxiliary storage unit by the CPU of the EMS 103. The functions of the power consumption processing unit 103b, the power control determining unit 103e, and the power control command generating unit 103f are implemented by the execution of various kinds of programs stored in the main storage unit or the auxiliary storage unit by the CPU of the EMS 103. The number storage unit 103c and the random number generation parameter storage unit 103d are storage areas which are ensured in, for example, the auxiliary storage unit of the EMS 103.

The communication control unit 103a controls communication with another apparatus, such as the MDMS 101. In particular, the communication control unit 103a receives the first total perturbated power consumption in the first unit time from the MDMS 101 or transmits a power control command to controls the power use to the SM 102a or the home server 102b.

The number storage unit 103c stores therein the number of SMs 102a managed by the MDMS 101. The number is the number of power consumption to be used for calculating the first total perturbated power consumption in each region, and the number in each region is stored in the number storage unit 103c. The random number generation parameter storage unit 103d stores therein random number parameters. The random number parameters are the same as those stored in the SM 102a and indicate, for example, the mean or variance of a given probability distribution. The random number generation parameter storage unit 103d may store therein other parameters, such as the skewness or kurtosis of the probability distribution when the other parameters are required to calculate the estimation value of the total power consumption.

The power consumption processing unit 103b cancels perturbation in the first total perturbated power consumption to calculate the estimation value of the total power consumption, using the first total perturbated power consumption received from the MDMS 101 through the communication control unit 103a, the number n stored in the number storage unit 103c, and the random number generation parameters stored in the random number generation parameter storage unit 103d. Specifically, the power consumption processing unit 103b subtracts “number n×mean μ=nμ” from the first total perturbated power consumption RZ calculated by Expression (1) so as to calculate the estimation value Z of the total power consumption. That is, the estimation value Z of the total power consumption is calculated by the following Expression (3):

Z=RZ−nμ (3)

Alternatively, the power consumption processing unit 103b may calculate an estimation value Z″ of the average of the total power consumption by subtracting the mean μ from the average value RZ″ of the first total perturbated power consumption calculated by the following Expression (4). That is, the estimation value Z″ of the average of the total power consumption is calculated by the following Expression (5):

RZ″=Σₘrz_{—}{m, j}/n (4)

Z″=RZ″−μ (5)

if each random variable has the same probability distribution as the others and all are mutually independent.

Each random number has the same probability distribution as the others and all are mutually independent, and the number n of SMs 102a managed by the MDMS 101 is very large. Therefore, by the central limit theorem, the first total perturbated power consumption RZ calculated by Expression (1) has a normal distribution N(nμ, nσ2) and the average value RZ″ of the first total perturbated power consumption calculated by Expression (4) has a normal distribution N(nμ, nσ2/n). Therefore, the value calculated by Expression (3) may be used as the estimation value of the actual total power consumption Z calculated by the following Expression (6) with a certain probability. In addition, the value calculated by Expression (5) may be used as the estimation value of the average value Z″ of the actual total power consumption calculated by the following Expression (7) with a certain probability (see Jakob Bernoulli, Ars Conjectandi: Usum & Applicationem Praecedentis Doctrinae in Civilibus, Moralibus & Oeconomicis, 1713, Chapter 4, (Translated into English by Oscar Sheynin)).

Z=Σₘz_{—}{m, j} (6)

Z″=Σₘz_{—}{m, j}/n (7)

The power control determining unit 103e determines whether to perform power control, on the basis of the estimation value of the total power consumption in the first unit time which is calculated by the power consumption processing unit 103b. For example, the power control is performed as follows: when the estimation value of the total power consumption is greater than an upper limit threshold, the power use in each home is controlled or the power use in a predetermined percentage of homes in decreasing order of the estimation value of the total power consumption is controlled; or when the estimation value of the total power consumption is less than a lower limit threshold, a rechargeable battery is charged. The power control determining unit 103e may store the estimation value of the total power consumption calculated by the power consumption processing unit 103b as data for making a power supply plan in the auxiliary storage unit and set the upper limit threshold or the lower limit threshold using the data for making the power supply plan. In addition, the power control determining unit 103e may determine whether to perform power control for controlling the power use in the home system 102 on the basis of the attribute of the home system 102, such as whether to allow in advance cooperation for reducing the power use. When the power control determining unit 103e determines to perform power control for controlling the power use in each home, the power control command generating unit 103f transmits a power control command to request the control of the power use from the communication control unit 103a to the home server 102b.

Next, various kinds of functions implemented by the charging server 104 will be described. FIG. 6 is a diagram illustrating an example of the functional structure of the charging server 104. As shown in FIG. 6, the charging server 104 includes a communication control unit 104a, a power consumption processing unit 104b, and a charging unit 104c. The function of the communication control unit 104a is implemented by the communication I/F of the charging server 104 and the execution of various kinds of programs stored in the main storage unit or the auxiliary storage unit by the CPU of the charging server 104. The functions of the power consumption processing unit 104b and the charging unit 104c are implemented by the execution of various kinds of programs stored in the main storage unit or the auxiliary storage unit by the CPU of the charging server 104.

The communication control unit 104a controls communication with another apparatus such as the MDMS 101. In particular, the communication control unit 104a transmits a charging process command to perform a charging system process to the MDMS 101 every second unit time, receives the second total perturbated power consumption of each home for the second unit time from the MDMS 101, transmits a random number request command generated by the power consumption processing unit 104b, which will be described below, to the SM 102a, or receives the total random number from the SM 102a in response to the random number request command.

The power consumption processing unit 104b controls the communication control unit 104a to transmit the charging process command to the MDMS 101 every second unit time, and controls the communication control unit 104a to transmit, to the SM 102a, a random number request command to request the transmission of the random numbers that have been used to perturbate the power consumption in the second unit time while designating the second unit time. Then, the power consumption processing unit 104b subtracts the total random number, which is received from the SM 102a through the communication control unit 104a in response to the random number request command, from the second total perturbated power consumption, which is received from the MDMS 101 through the communication control unit 104a in response to the charging process command, thereby cancelling perturbation in the second total perturbated power consumption. As a result of this calculation, the third total power consumption of the home system 102 in the second unit time is obtained. The charging unit 104c performs a charging process on the basis of the third total power consumption of the home system in the second unit time which is calculated by the power consumption processing unit 104b.

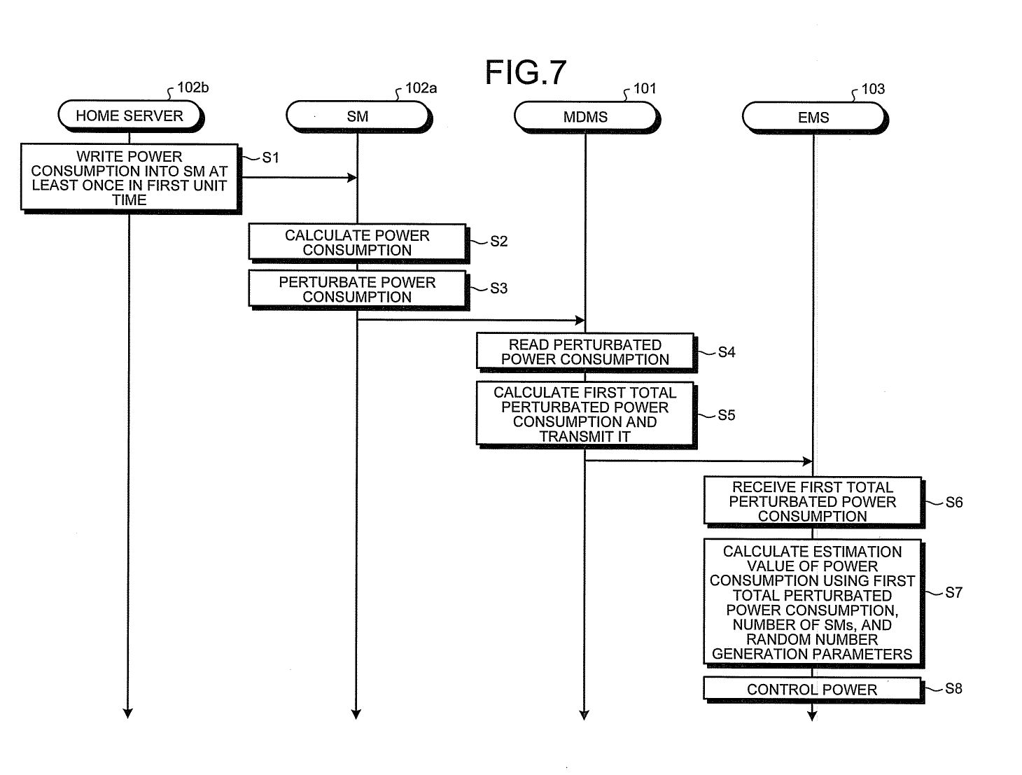

Next, the procedure of the process performed by the power consumption calculating system according to this embodiment will be described. First, the procedure of a total power consumption calculating process will be described with reference to FIG. 7. The home server 102b writes the amount of power consumption of the electric appliance 102c connected thereto into the SM 102a at least once in the first unit time (Step S1). Similarly, the electric appliance 102d writes its power consumption into the SM 102a at least once in the first unit time. The SM 102a calculates, for each first unit time, the written power consumption z_{i, j} of the electric appliances 102c and 102d and stores it in the power consumption storage unit 102a3 (Step S2). In the case where the SM 102a mechanically measures the power consumption, Step S1 is omitted and the SM 102a adds up the mechanically measured power consumption in Step S2.

Then, the SM 102a generates random numbers using the random number parameters stored in the random number generation parameter storage unit 102a6, adds the random numbers r_{i, j} to the calculated power consumption to thereby perturbate the power consumption, and stores the perturbated power consumption rz_{i, j} in the power consumption storage unit 102a3 (Step S3).

The MDMS 101 reads the perturbated power consumption rz_{i, j} stored in the SM 102a at least once in the first unit time and stores it in the perturbated power consumption storage unit 101d (Step S4). In this case, the MDMS 101 also reads the home identification information given to the home system 102 from the SM 102a and stores the home identification information in the perturbated power consumption storage unit 101d so as to be associated with the perturbation power consumption rz_{i, j}. Then, the MDMS 101 calculates the first total perturbated power consumption RZ of a plurality of home systems 102 using Expression (1), stores the first total perturbated power consumption RZ in the perturbated power consumption storage unit 101d, and transmits the first total perturbated power consumption RZ to the EMS 103 (Step S5). When the first total perturbated power consumption RZ will not be used further, the MDMS 101 may delete the first total perturbated power consumption RZ from the perturbated power consumption storage unit 101d. In addition, the MDMS 101 may read the perturbated power consumption in Step S4 or delete the perturbated power consumption, in response to a request from the EMS 103.

The EMS 103 receives the first total perturbated power consumption RZ transmitted from the MDMS 101 and stores it in, for example, the main storage unit every first unit time (Step S6). Then, the EMS 103 cancels perturbation in the first total perturbated power consumption using the first total perturbated power consumption received in Step S6, the random number generation parameters stored in the random number generation parameter storage unit 103d, and the number stored in the number storage unit 103c, so as to calculate the estimation value of the total power consumption, and stores the estimation value in, for example, the main storage unit (Step S7).

Then, the EMS 103 performs power control on the basis of the estimation value of the total power consumption (Step S8). When the EMS 103 determines to perform power control to control the power used in each home, it transmits a power control command to request the control of the power use to the home server 102b. After Step S8, the EMS 103 may delete the first total perturbated power consumption and the estimation value of the total power consumption from the main storage unit. When receiving the power control command, analyzing that the content of the power control command requests the control of the power use, and determining to accede to the request, the home server 102b controls the amount of power used by the electric appliance 102c connected to the home server 102b.

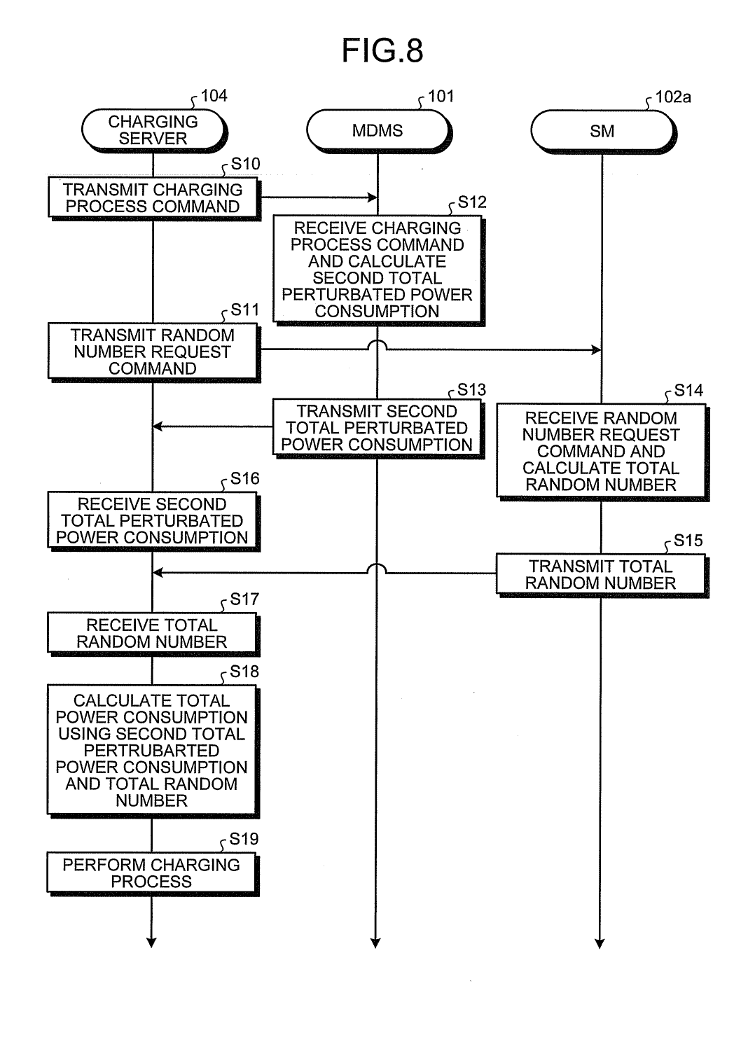

Next, the procedure of the charging system process performed by the power consumption calculating system will be described. When the power consumption calculating process described with reference to FIG. 7 is performed, the MDMS 101 stores the second total perturbated power consumption of each home in the perturbated power consumption storage unit 101d so as to be associated with the home identification information. The charging server 104 performs a charging process on the total power consumption obtained by cancelling the perturbation in the second total perturbated power consumption of each home every second unit time. The procedure of the charging system process including the charging process will be described with reference to FIG. 8. First, the charging server 104 transmits a charging process command to perform the charging system process to the MDMS 101 every second unit time (Step S10). The charging process command designates the second unit time and the home identification information to be subjected to the charging process. The charging process command may not be transmitted from the charging server 104, but may be transmitted from the MDMS 101 to the charging server 104. The charging server 104 designates the second unit time and transmits, to the SM 102a corresponding to the home identification information designated by the charging process command, a random number request command to request the transmission of the random numbers that have been used to perturbate the amounts of power consumption corresponding to the first unit times included in the designated second unit time (Step S11).

When receiving the charging process command, the MDMS 101 reads the perturbated power consumption corresponding to the designated home identification information in each first unit time included in the second unit time from the perturbated power consumption storage unit 101d, adds up the perturbation power consumption to calculate the second total perturbated power consumption, and stores the second total perturbated power consumption in the perturbated power consumption storage unit 101d (Step S12). Then, the MDMS 101 transmits the second total perturbated power consumption calculated in Step S12 to the charging server 104 (Step S13). However, after a predetermined period of time elapses, the MDMS 101 may delete the second total perturbated power consumption from the perturbated power consumption storage unit 101d. The predetermined period of time is a period during which there is possibility that the charging server 104 requests the retransmission of the second total perturbated power consumption and is, for example, 3 months.

When receiving the random number request command, the SM 102a acquires, from the random number storage unit 102a7, the random number that has been used to perturbate power consumption of each first unit time included in the second unit time designated by the random number request command and adds up the random numbers to calculate a total random number (Step S14). Then, the SM 102a transmits the total random number generated in Step S14 to the charging server 104 (Step S15).

When receiving the second total perturbated power consumption from the MDMS 101, the charging server 104 stores the second total perturbated power consumption in the main storage unit (Step S16). When receiving the total random number from the SM 102a, the charging server 104 stores the total random number in the main storage unit (Step S17). Then, the charging server 104 subtracts the total random number from the second total perturbated power consumption to obtain the total power consumption of the home system 102 in the second unit time, and stores the total power consumption in the main storage unit (Step S18). The charging unit 104c performs a charging process on the basis of the total power consumption of the home system in the second unit time which is calculated in Step S18 (Step S19). After Step S19, the charging server 104 may delete the second total perturbated power consumption, the total random number, or the total power consumption from the main storage unit.

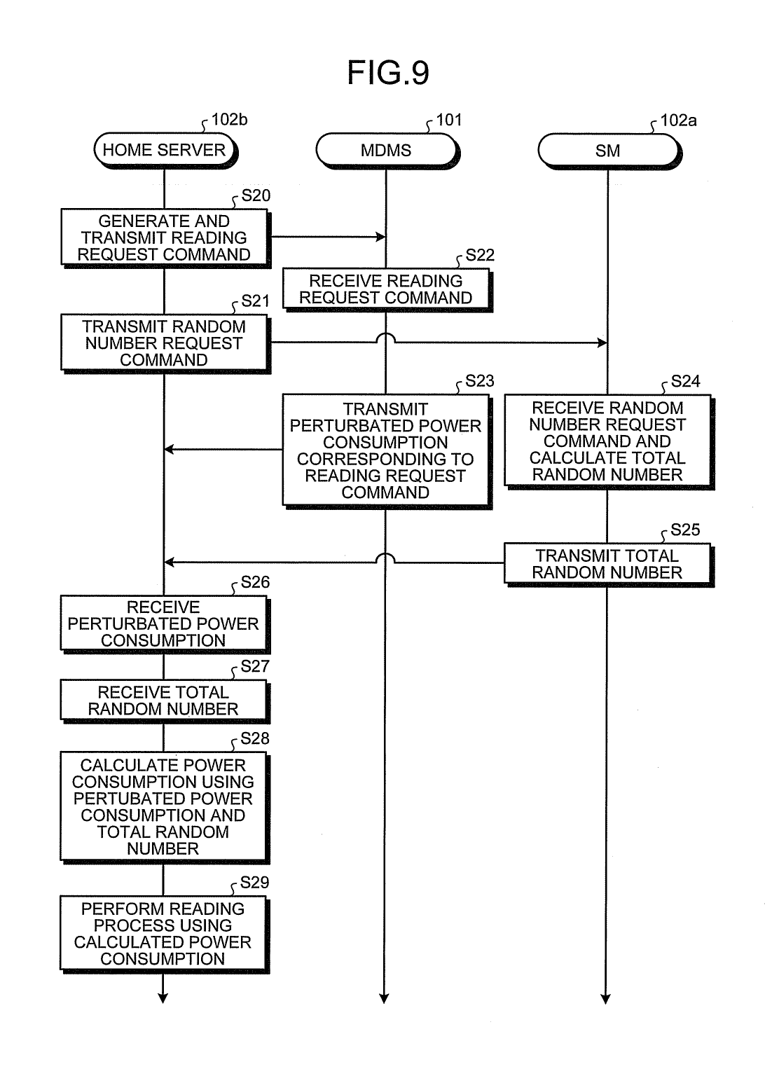

Next, the procedure of a reading request process performed by the power consumption calculating system will be described. When the power consumption calculating process described with reference to FIG. 7 is performed, the MDMS 101 stores the perturbated power consumption in each home for one or more first unit times in the perturbated power consumption storage unit 101d so as to be associated with the home identification information. The procedure of the reading request process in which the home system 102 requests the MDMS 101 to read power consumption will be described with reference to FIG. 9. The home server 102b of the home system 102 generates a reading request command to request the reading of power consumption and transmits the reading request command to the MDMS 101 (Step S20). In addition, the home server 102b designates a desired reading period, generates a random number request command to request a random number that have been used to perturbate the amounts of power consumption in the desired reading period, and transmits the random number request command to the SM 102a (Step S21).

When receiving the reading request command (Step S22), the MDMS 101 reads, from the perturbated power consumption storage unit 101d, perturbated power consumption corresponding to each first unit time included in the reading request period among the perturbated power consumption corresponding to the home identification information designated by the reading request command, and transmits the perturbated power consumption to the home server 102b (Step S23).

When receiving the random number request command, the SM 102a acquires, from the random number storage unit 102a7, the random numbers that have been used to perturbate the amounts of power consumption corresponding to the first unit times included in the desired reading time designated by the random number request command and adds up the random numbers to calculate the total random number (Step S24). Then, the SM 102a transmits the calculated total random number to the home server 102b through the communication control unit 102a1 (Step S25).

When receiving the perturbated power consumption from the MDMS 101, the home server 102b stores the perturbated power consumption in the main storage unit (Step S26). When receiving the total random number from the SM 102a, the home server 102b stores the total random number in the main storage unit (Step S27). The home server 102b controls the perturbation cancellation unit 102b2 to cancel perturbation in the perturbated power consumption using the perturbated power consumption and the total random number. As a result of this calculation, the home server 102b obtains power consumption and stores the power consumption in the main storage unit (Step S28). Then, the home server 102b displays the power consumption calculated in Step S28 on the display unit (Step S29). After Step S29, the home server 102b may delete the perturbation power consumption, the total random number, or the power consumption from the main storage unit.

As described above, the meter data management system can conceal the power consumption measured by each power meter to protect privacy and can calculate the total power consumption or the estimation value of the total power consumption. In addition, it is possible to control electric appliances in each home according to tight power conditions to perform interactive dynamic power control between a consumer and supplier, such as the optimization of power consumption in a region or the prevention of a power failure. In addition, it is possible to calculate accurate power consumption measured by each power meter in the second unit time, without disclosing the temporal variations in power consumption, and perform a charging process.

The invention is not limited to the above-described embodiment, but the components may be modified or changed without departing from the scope of the invention. In addition, a plurality of components according to the above-described embodiment of the invention may be appropriately combined with each other to form various structures. For example, some of the components according to the above-described embodiment may be removed. The following various modifications can be made.

In the above-described embodiment, various kinds of programs executed by at least one of the MDMS 101, the SM 102a, the home server 102b, the EMS 103, and the charging server 104 may be stored in a computer connected to a network, such as the Internet, downloaded through the network, and then provided. In addition, the various kinds of programs may be stored as a file of an installable format or an executable format in a computer-readable storage medium, such as a CD-ROM, a flexible disk (FD), a CD-R, or a DVD (Digital Versatile Disk), and then provided as a computer program product.

In the above-described embodiment, the SM 102a periodically calculates power consumption every first unit time, but the invention is not limited thereto. The SM 102a may calculate power consumption at any timing.

In the above-described embodiment, cryptographic communication, such as OpenSSL, may be used as the communication between the MDMS 101 and the charging server 104, the communication between the MDMS 101 and the EMS 103, the communication between the SM 102a and the MDMS 101, and the communication between the MDMS 101 and the home server 102b in order to keep information secret. In addition, during the communication between apparatuses, authentication may be performed in order to authenticate the apparatuses.

For example, when the content of the communication between the SM 102a and the MDMS 101 is encrypted or authenticated, the SM 102a stores a code or an authenticator obtained by encoding the perturbated power consumption which is obtained by perturbating the power consumption calculated every first unit time. The MDMS 101 decodes the cryptogram read from the SM 102a to restore the perturbated power consumption.

In the above-described embodiment, the SM 102a may have a function of voluntarily transmitting information to the MDMS 101 according to a predetermined program or an instruction from another apparatus. In this case, when the content of the communication between the SM 102a and the MDMS 101 is encrypted or authenticated, the SM 102a may store the perturbated power consumption obtained by perturbating the power consumption calculated every first unit time in the power consumption storage unit 102a3, read the perturbated power consumption from the power consumption storage unit 102a3 when transmitting the perturbated power consumption to the MDMS 101, encrypt the perturbated power consumption or add an authenticator to the perturbated power consumption, and then transmit it.

In the above-described embodiment, a plurality of MDMSs 101 may be connected to the EMS 103. In this case, the EMS 103 may calculate the estimation value of the total power consumption for each MDMS 101. When the random number generation parameters are common to a plurality of MDMSs 101, the EMS 103 may calculate the estimation value of the total power consumption for the perturbated power consumption transmitted from all of the MDMSs 101.

In the above-described embodiment, the random number generating unit 102a5 of the SM 102a generates the random numbers whenever the power consumption perturbating unit 102a2 perturbates power consumption. However, the random number generating unit 102a5 may use the same random number plural times, or it may generate a plurality of random numbers in advance, store the random numbers in a table, and select the random number from the table. In this case, the random number generating unit 102a5 may have a rule in which the same random number is selected according to the time. In this way, it is possible to reduce, for example, a mounting load or a processing load.

In the above-described embodiment, the SM 102a may delete the random numbers stored in the random number storage unit 102a7 after a predetermined period of time elapses, or it may store the random numbers in another apparatus including the MDMS 101 or the home server 102b for backup. In this case, the SM 102a may encrypt the random numbers with a key stored in the SM 102a or the home server 102b. In this way, it is possible to reduce the risk when the back-up random numbers leak. In addition, the SM 102a may store the total random number obtained by adding up the random numbers within a specific period of time for which power consumption every first unit time is not required in the random number storage unit 102a7. In this case, it is possible to reduce storage capacity or calculate a detailed power consumption history even when both the perturbated power consumption and the random numbers leak. For example, the SM 102a may store the sum of the random numbers generated by the random number generating unit 102a5 within the second unit time before three measurement operations (in general, before three months) in the random number storage unit 102a7.

In the above-described embodiment, when the random number acquiring unit 102a8 of the SM 102a responds to the random number request command frequently issued by the charging server 104, the effect of adding up the random numbers in order to perturbate the actual power consumption is reduced. Therefore, the random number acquiring unit 102a8 may be configured not to respond to the random number request command that is frequently issued a predetermined number of times or more by the charging server 104. In this way, the protection of privacy is improved. In addition, the random number acquiring unit 102a8 may delete the random numbers and the total random number used in response to the random number request command from the random number storage unit 102a7 in response to a request from the charging server 104, the SM 102a, or the home server 102b. In this way, even when there is an illegal access to the SM 102a, it is possible to prevent the leakage of the random numbers and to prevent the power consumption from being calculated from the perturbated power consumption.

In the above-described embodiment, the SM 102a receives the random number request command from the charging server 104 and transmits the total random number to the charging server 104 in response to the random number request command. However, the SM 102a may receive the random number request command and transmit the total random number through the MDMS 101. In this case, the MDMS 101 may transmit the second total perturbated power consumption together with the total random number to the charging server 104. In this case, the SM 102a may encrypt the total random number with, for example, a common key shared with the charging server 104 or a public key of the charging server 104 such that the total random number does not leak to the MDMS 101.

In the above-described embodiment, the perturbation processing method of the SM 102a performed on power consumption using the random numbers is not limited to the above-mentioned example. The perturbation processing may be performed by some or all of the SMs 102a connected to the MDMS 101. The MDMS 101 may cancel perturbation in the perturbated power consumption transmitted from the SM 102a that has performed the perturbation processing.

The perturbation processing may be performed by the MDMS 101, not the SM 102a. In this case, the MDMS 101 stores the random number parameters stored in the SM 102a in advance. The SM 102a may store the power consumption measured every first unit time in the power consumption storage unit 102a3, and the MDMS 101 may read the power consumption stored in the SM 102a at least once in the first unit time, store the read power consumption, generate random numbers using the random number parameters, add the random numbers to the power consumption to calculate perturbated power consumption, and store the perturbated power consumption in the perturbated power consumption storage unit 101d.

In the above-described embodiment, the home server 102b directly communicates with the MDMS 101 through, for example, the network. However, the home server 102b may communicate with the MDMS 101 through, for example, the SM 102a and the network.

In the above-described embodiment, the number storage unit 103c of the EMS 103 stores the number of SMs 102a managed by the MDMS 101, but the invention is not limited thereto. The EMS 103 may store in advance the home identification information given to each of the home systems managed by the MDMS 101, and count the number of home identification information items when using the number of SMs 102a, thereby obtaining the number of SMs 102a.

In the above-described embodiment, the SM 102a uses the probability distribution having a mean of “0” to generate the random numbers. Therefore, the EMS 103 can directly calculate the total power consumption, not the estimation value thereof, from the first total perturbated power consumption without using the random number generation parameters and calculate the average value of the total power consumption from the average value of the first total perturbated power consumption. In this case, the EMS 103 may not include the number storage unit 103c.

In the above-described embodiment, the random number acquiring unit 102a8 of the SM 102a transmits the sum of the random numbers that have been used to perturbate the amounts of power consumption corresponding to the first unit times included in the desired reading time to the home server 102b in response to the random number request command received from the home server 102b, but the invention is not limited thereto. The random number acquiring unit 102a8 may individually transmit the random numbers that have been used to perturbate the amounts of power consumption corresponding to the first unit times included in the desired reading time to the home server 102b, or transmit the sum of at least two of the random numbers to the home server 102b. In this case, the home server 102b may calculate the sum of the random numbers used to perturbate the amounts of power consumption in the desired reading time, using the value transmitted from the SM 102a in response to the reading request command, thereby acquiring the total random number.

Similarly, in the above-described embodiment, the random number acquiring unit 102a8 of the SM 102a transmits the sum of the random numbers used to perturbate the amounts of power consumption corresponding to the first unit times included in the second unit time to the charging server 104 in response to the random number request command received from the charging server 104, but the invention is not limited thereto. The random number acquiring unit 102a8 may individually transmit the random numbers that have been used to perturbate the amounts of power consumption corresponding to the first unit times included in the second unit time to the charging server 104, or transmit the sum of at least two of the random numbers to the charging server 104. In this case, the charging server 104 may calculate the sum of the random numbers that have been used to perturbate the amounts of power consumption in the second unit time, using the value transmitted from the SM 102a in response to the perturbation request command, thereby acquiring the total random number.

In the above-described embodiment, when the EMS 103 determines to perform power control, it transmits the power control command to the home server 102b. Instead, the EMS 103 may transmit the power control command to the SM 102a. In this case, the SM 102a may include a power control command analyzing unit that analyzes the content of the power control command and outputs an appliance power control command to request the control of the power used by the electric appliance 102d connected to the SM 102a to an appliance control unit according to the content, and the appliance control unit that controls the power used by the electric appliance 102d in response to the appliance power control command, similar to the power control command analyzing unit 102b4 and the appliance control unit 102b5 of the home server 102b.

In the above-described embodiment, the EMS 103 performs power control using the estimation value of the total power consumption. Instead, the EMS 103 may generate new random number generation parameters, notify the SM 102a of the new random number generation parameters, and share the new random number generation parameters with the SM 102a. In this way, it is possible to change the accuracy of the estimation value of the total power consumption and perform power control according to a supply or demand plan or supply and demand conditions. For example, during the period for which the supply and demand conditions are tight, such as the summer, the variance of the random number generation parameters is set to a small value, and the variance of the normal distribution of the estimation value of the total power consumption calculated from the first total perturbated power consumption or the estimation value of the average of the total power consumption is reduced. Therefore, it is possible to improve the accuracy of the estimation value of the total power consumption. As a result, it is possible to perform strict power control. On the contrary, when the variance is set to a large value, the strength of perturbation increases. Therefore, it is possible to reliably ensure privacy. As an extreme example, when very high strength is required, the perturbation processing using the random numbers may stop.

When some of a plurality of SMs 102a do not perform the perturbation processing, the EMS 103 may accurately check supply and demand conditions from the total power consumption, which is the sum of power consumption calculated by each SM 102a, or the average value of the power consumption and determine the random number generation parameters fed back to the SM 102a that has performed the perturbation processing. For example, when the perturbation processing using the random numbers is optional or when a reward is given to the user who opens privacy information, the SMs 102a may be classified into a group of the SMs 102a that perform the perturbation processing and a group of the SMs 102a that do not perform the perturbation processing. When the correspondence between the home identification information of the SMs 102a in each group and whether to perform the perturbation processing is stored in the MDMS 101, the MDMS 101 calculates the first total perturbated power consumption for each group and transmits the first total perturbated power consumption and information indicating whether to perform perturbation processing to the EMS 103. The EMS 103 can calculate accurate the total power consumption that is not subjected to perturbation processing or the average value of the total power consumption. The EMS 103 can check the difference from the supply and demand plan or the supply and demand conditions on the basis of the value and change the random number generation parameters on the basis of the check result as described above to adjust the accuracy of the estimation value of the total power consumption, thereby performing accurate power control.

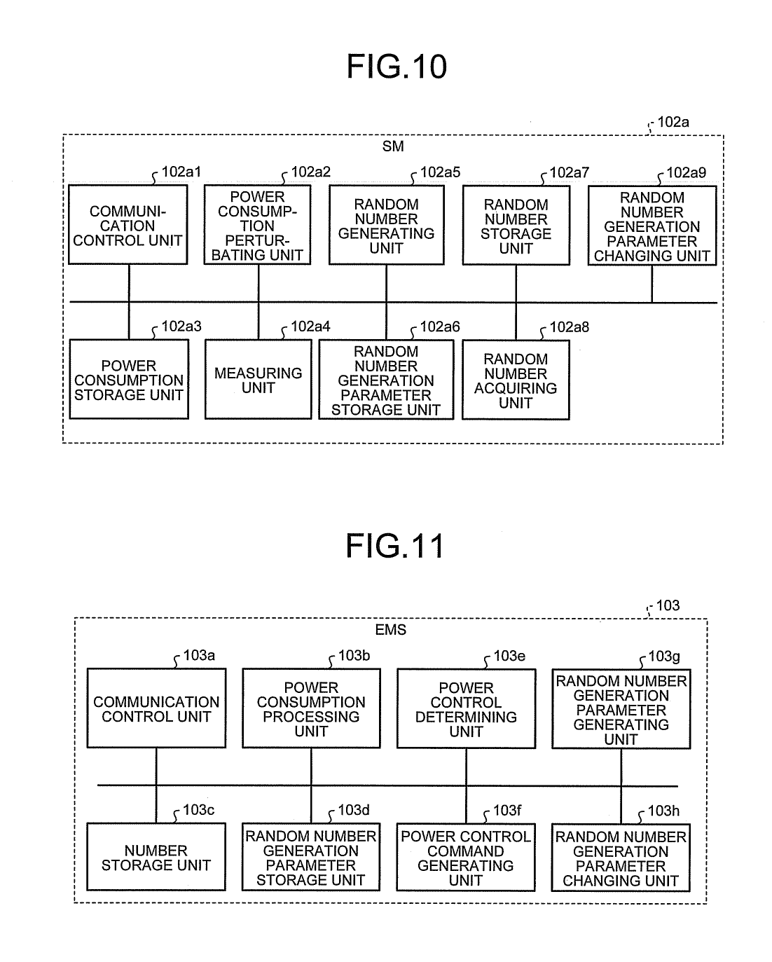

FIG. 10 is a diagram illustrating an example of the functional structure of the SM 102a according to a modification. The SM 102a includes a random number generation parameter changing unit 102a9 in addition to the structure shown in FIG. 2. The function of the random number generation parameter changing unit 102a9 is implemented by the execution of various kinds of programs stored in the main storage unit or the auxiliary storage unit by a CPU of the SM 102a. The communication control unit 102a1 receives new random number generation parameters from the EMS 103. The random number generation parameter changing unit 102a9 stores the new random number generation parameters received from the EMS 103 through the communication control unit 102a1 in the random number generation parameter storage unit 102a6.

FIG. 11 is a diagram illustrating an example of the structure of the functional structure of the EMS 103 according to the modification. The EMS 103 includes a random number generation parameter generating unit 103g and a random number generation parameter changing unit 103h in addition to the structure shown in FIG. 5. The functions of the above-mentioned units are implemented by the execution of various kinds of programs stored in the main storage unit or the auxiliary storage unit by a CPU of the EMS 103. The random number generation parameter generating unit 103g determines whether the accuracy of the estimation value of the total power consumption needs to be changed on the basis of the difference between the estimation value of the total power consumption and the supply and demand plan. For example, when it is determined that the estimation value of the total power consumption is a predetermined percent more than the supply and demand plan, the random number generation parameter generating unit 103g determines that the accuracy needs to be changed. When it is determined that the accuracy of the estimation value of the total power consumption needs to be changed, the random number generation parameter generating unit 103g calculates new random number generation parameters. For example, as described above, when high accuracy is required, the random number generation parameter generating unit 103g calculates new random number generation parameters so as to have a variance smaller than the random number parameters stored in the random number generation parameter storage unit 102a6. The random number generation parameter changing unit 103h changes the random number parameters stored in the random number generation parameter storage unit 103d to the random number generation parameters calculated by the random number generation parameter generating unit 103g.

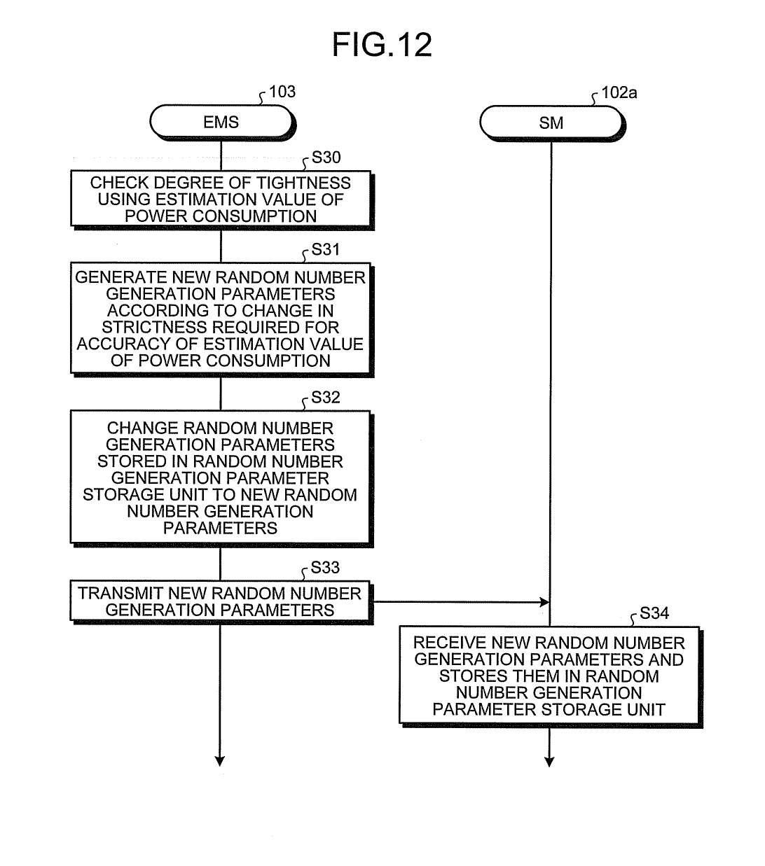

Next, the procedure of a process of generating new random number generation parameters using the estimation value of the total power consumption calculated by the EMS 103 in Step S7 of FIG. 7 will be described with reference to FIG. 12. The EMS 103 checks the difference between the estimation value of the total power consumption and the supply and demand plan or the degree of tightness of supply and demand conditions (Step S30). The EMS 103 generates new random number generation parameters for changing the random numbers generated by the SM 102a according to a change in strictness required for the accuracy of the estimation value of the total power consumption (Step S31). The EMS 103 changes the random number generation parameters stored in the random number generation parameter storage unit 103d to the new random number generation parameters generated in Step S31 (Step S32). The EMS 103 transmits the new random number generation parameters generated in Step S31 to the SM 102a (Step S33). The SM 102a receives the new random number generation parameters from the EMS 103, and stores them in the random number generation parameter storage unit (Step S34). The new random number parameters may be transmitted to the SM 102a through the MDMS 101. The SM 102a stores the new random number generation parameters transmitted from the EMS 103 in the random number generation parameter storage unit 102a6 and uses the new random number generation parameters to generate random numbers in the next process.

According to the above-mentioned structure, it is possible to increase the accuracy of the estimation value of the total power consumption according to the tightness of power supply and demand conditions and rigidly perform the perturbation of the amount of power consumption.

When transmitting the new random number generation parameters in Step S33, the EMS 103 may also transmit information indicating the time when the generation of the random numbers using the random number generation parameters starts. According to this structure, it is possible to prevent a reduction in the accuracy of the estimation value of the total power consumption due to the mixture of new and old random number generation parameters.

The changed random number generation parameters may be shared by the SM 102a and the EMS 103 in advance. For example, different kinds of random number generation parameter sets, such as a random number generation parameter set A used from January to March and a random number generation parameter set B used in August, may be shared by the SM 102a and the EMS 103. Parameter identification information may be given to each random number generation parameter set such that the random number generation parameter set can be identified, and the SM 102a and the EMS 103 may share the parameter identification information. The SM 102a and the EMS 103 do not directly transmit or receive the random number generation parameters, but may transmit or receive the parameter identification information to indirectly notify each other of the random number generation parameters. In this way, it is possible to reduce the time and effort required for communication or to reduce data capacity during communication.

The EMS 103 and the SM 102a may share a common key, a public key, or a secret key, and the EMS 103 may encrypt the new random number generation parameters with these keys and transmit the encrypted new random number generation parameters to the SM 102a. In this way, it is possible to prevent an illegal action to acquire the total perturbated power consumption, the perturbated power consumption, or the random number generation parameters transmitted through a communication line to obtain the estimation value of the total power consumption or an attack to make a change in power consumption clear using, for example, statistical analysis.

In the above-described embodiments, the charging server 104 performs the charging process on the basis of the total amount of power consumption of each home in the second unit time. In the smart grid, a unit cost increases during a period of time during which a large amount of power is consumed (an electricity unit cost is high). Even when this dynamic pricing is performed, it is possible to perform the charging system process using the perturbated power consumption of each home stored in the MDMS 101 and the random numbers stored in the SM 102a. The price of electricity is changed every first unit time or is equal to the previous price, and k power unit costs corresponding to the first unit times included in the second unit time are p_{i, 1}, p_{i, 2}, . . . , p_{i, k}. For example, when the power unit cost is constantly 10 yen in the second unit time, k=1 and p_{i, 1}=10 are established. When the power unit cost is 15 yen at the peak of the day, the power unit cost is 5 yen in the night, and the power unit cost is 10 yen in the other period of time, k=3, p_{i, 1}=5 (night), p_{i, 2}=10 (ordinary times), and p_{i, 3}=15 (peak) are established. The power unit cost may be changed every day, not each period of time during the day.

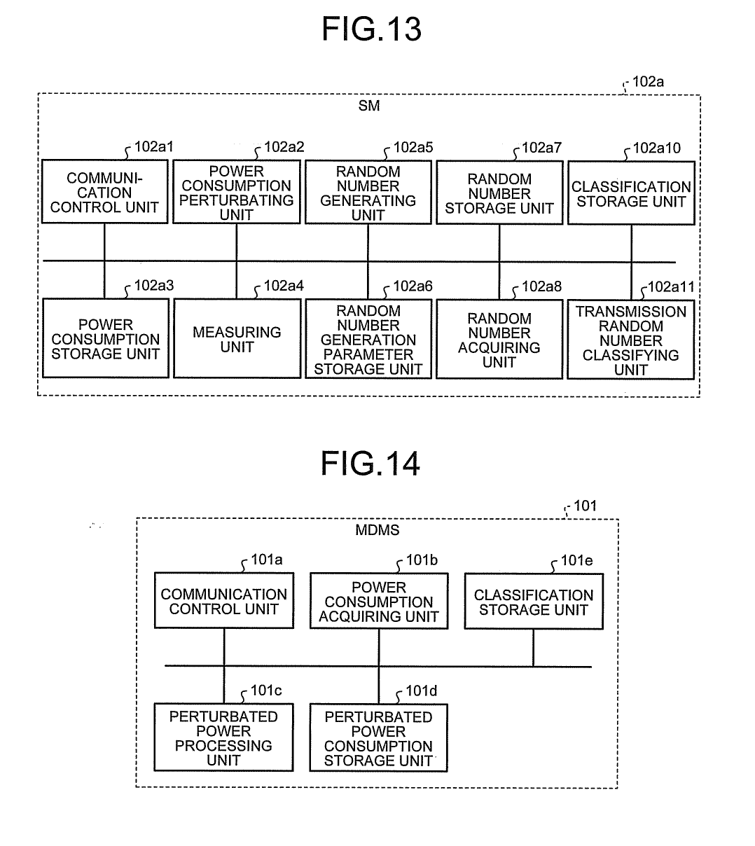

FIG. 13 is a diagram illustrating an example of the functional structure of an SM 102a according to a modification. The SM 102a includes a classification storage unit 102a10 and a transmission random number classifying unit 102a11, in addition to the structure shown in FIG. 2. The classification storage unit 102a10 is a storage area that is ensured in, for example, an auxiliary storage unit of the SM 102a. The function of the transmission random number classifying unit 102a11 is implemented by the execution of various kinds of programs stored in the main storage unit or the auxiliary storage unit by a CPU of the SM 102a. The classification storage unit 102a10 stores therein classification information which is for classifying the random numbers and is related to the power unit cost every first unit time. The classification information indicates the classification k of the power unit cost p_{i, k} to which a first unit time j belongs every first unit time. The classification information does not necessarily indicate the power unit cost p_{i, k}, but any classification information may be used as long as it can determine that a given first unit time and another first unit time belong to the same classification and the charging server 104 can determine the power unit cost p_{i, k} corresponding to the classification k. A static method of determining the classification of the value of the power unit cost in advance on the basis of, for example, the period of time including the first unit time (morning, afternoon, and evening) or four seasons may be used, a dynamic method in which the EMS 103 or the MDMS 101 dynamically notifies the SM 102a of the classification according to tight power supply and demand conditions may be used, or the static method and the dynamic method may be combined with each other.

The transmission random number classifying unit 102a11 adds up the random numbers for each classification k to calculate the total random number for each classification when the random number acquiring unit 102a8 calculates the total random number in response to the random number request command transmitted from the charging server 104, and transmits the total random number for each classification and an index j of the first unit time belonging to the classification to the charging server 104 through the communication control unit 102a1. In addition, when knowing the power unit cost p_{i, k} of the classification, the transmission random number classifying unit 102a11 may also transmit the power unit cost p_{i, k} to the charging server 104 through the communication control unit 102a1.

FIG. 14 is a diagram illustrating an example of the functional structure of the MDMS 101 according to a modification. The MDMS 101 includes a classification storage unit 101e in addition to the structure shown in FIG. 4. The classification storage unit 101e is a storage area that is ensured in, for example, an auxiliary storage unit of the MDMS 101. The classification storage unit 101e stores therein classification information related to the power unit cost of each home system i for each first unit time j. The classification information indicates the classification k of the power unit cost p_{i, k} to which the first unit time j belongs for each first unit time of each home system i. The classification information does not necessarily indicate the power unit cost p_{i, k}, but any classification information may be used as long as it can determine that a given first unit time and another first unit time belong to the same classification and the charging server 104 can determine the power unit cost p_{i, k} corresponding to the classification k. The value of the power unit cost corresponding to the classification may be determined by: a static method in which the classification is determined in advance on the basis of, for example, the period of time including the first unit time (morning, afternoon, and evening) or the season; a dynamic method in which the value of the power unit cost is notified by the EMS 103 or the MDMS 101 determines the value of the power unit cost; or the combination of the static method and the dynamic method. In this configuration, the perturbated power processing unit 101c calculates total perturbated power consumption RZ′_{k} for each classification k with reference to the classification information stored in the classification storage unit 101e and stores the total perturbated power consumption RZ′_{k} in the perturbated power consumption storage unit 101d.

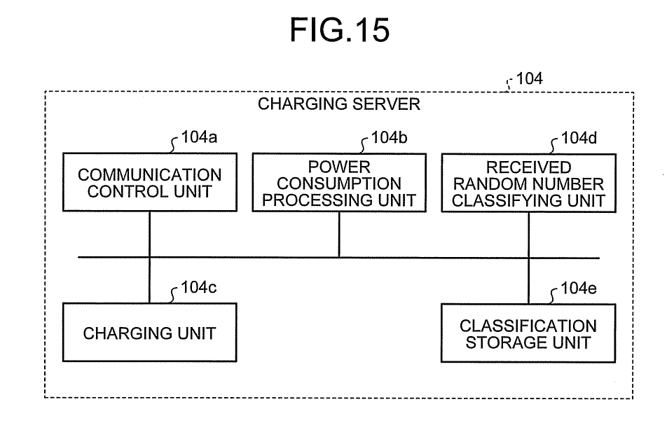

FIG. 15 is a diagram illustrating an example of the functional structure of the charging server 104 according to a modification. The charging server 104 further includes a received random number classifying unit 104d and a classification storage unit 104e. The received random number classifying unit 104d is implemented by the execution of various kinds of programs stored in the main storage unit or the auxiliary storage unit by a CPU of the charging server 104. The classification storage unit 104e is a storage area that is ensured in, for example, an auxiliary storage unit of the charging server 104. The classification storage unit 104e stores therein the correspondence between the classification and the power unit cost and stores therein the power unit cost for each classification. The received random number classifying unit 104d receives the total random number calculated for each classification which is transmitted from the SM 102a in response to the random number request command through the communication control unit 104a, receives the total perturbated power consumption for each classification which is transmitted from the MDMS 101 in response to the charging process command through the communication control unit 104a, and classifies the total random number and the total perturbated power consumption according to the classifications. The power consumption processing unit 104b subtracts, for each classification, the total random number from the total perturbated power consumption to thereby calculate the total power consumption for each classification, using the total random number and the total perturbated power consumption classified according to the classifications by the received random number classifying unit 104d. The charging unit 104c performs a charging process of multiplying the total power consumption of the home system for each classification in the second unit time which is calculated by the power consumption processing unit 104b by the power unit cost corresponding to each classification.

Next, the procedure of a power consumption calculating process according to a modification will be described. The process is substantially the same as that shown in FIG. 7 and illustration thereof will be omitted. Steps S1 and S2 are the same as those in the embodiment. In Step S3, the SM 102a calculates, for each classification k, the perturbated power consumption RZ′_{k} for the first unit time and stores the perturbated power consumption RZ′_{k} in the power consumption storage unit 102a3. In Step S4, the MDMS 101 reads the perturbated power consumption RZ′_{k} stored for each classification k by the SM 102a at least once in the first unit time and stores the perturbated power consumption RZ′_{k} in the perturbated power consumption storage unit 101d. In this case, the MDMS 101 also reads the home identification information given to the home system 102 from the SM 102a and stores the home identification information in the perturbated power consumption storage unit 101d so as to be associated with the perturbated power consumption RZ′_{k}. In Step S5, the MDMS 101 calculates the first total perturbated power consumption RZ of a plurality of home systems 102 using Expression (1), regardless of the classification k and transmits the first total perturbated power consumption RZ to the EMS 103. Steps S6 to S8 are the same as those in the first embodiment.

Next, the procedure of a charging system process according to a modification will be described. The process is substantially the same as that shown in FIG. 8 and illustration thereof will be omitted. The Steps S10 and S11 are the same as those in the embodiment. In Step S12, the MDMS 101 calculates, for each classification k, the total perturbated power consumption RZ′_{k} and stores the total perturbated power consumption RZ′_{k} in the perturbated power consumption storage unit 101d. In Step S13, the MDMS 101 transmits the total perturbated power consumption calculated for each classification in Step S12 to the charging server 104. In Step S14, when receiving a random number request command, the SM 102a acquires the random numbers that have been used to perturbate the amounts of power consumption corresponding to the first unit times included in the second unit time designated by the random number request command from the random number storage unit 102a7, and adds up the random numbers for each classification to calculate the total random number for each classification with reference to the classification information stored in the classification storage unit 101e. In Step S15, the SM 102a transmits the total random number for each classification generated in Step S14 and the index j of the first unit time belonging to each classification to the charging server 104.

In Step S16, when receiving the total perturbated power consumption for each classification from the MDMS 101, the charging server 104 stores the total perturbated power consumption in the main storage unit. In Step S17, when receiving the total random number for each classification and the index j of the first unit time belonging to each classification from the SM 102a, the charging server 104 stores them in the main storage unit. In Step S18, the charging server 104 classifies the total random number and the total perturbated power consumption according to the classifications, and subtracts, for each classification, the total random number from the total perturbation power consumption to thereby calculate the total power consumption for each classification, using the total random number and the total perturbated power consumption for each classification. In Step S19, the charging server 104 multiplies the total power consumption for each classification calculated in Step S18 by the power unit cost corresponding to each classification, with reference to the power unit cost for each classification stored in the classification storage unit 104e, thereby a charging process for the home system in the second unit time.

According to the above-mentioned structure, even when the price of electricity is dynamically changed depending on tight power supply and demand conditions, the charging server 104 can accurately perform the charging process.

In Step S12, when calculating the total perturbated power consumption for each classification, the MDMS 101 may multiply the total perturbated power consumption for each classification by the power unit cost corresponding to each classification. In Step S13, the MDMS 101 may transmit the total perturbated power consumption multiplied by the power unit cost for each classification to the charging server 104. Similarly, in Step S14, when calculating the total random number for each classification, the SM 102a may multiply the total random number for each classification by the power unit cost corresponding to each classification. In Step S15, the SM 102a may transmit the total random number multiplied by the power unit cost for each classification to the charging server 104. In this case, in Step S18, the charging server 104 may subtract the value received from the SM 102a from the value received from the MDMS 101 to obtain a value corresponding to the power rate.

In the above-described embodiment, the EMS 103 calculates the total power consumption or the estimation value of the average of the total power consumption. However, the MDMS 101 may the total power consumption or the estimation value of the average of the total power consumption. In this case, the MDMS 101 further includes the number storage unit 103c, the random number generation parameter storage unit 103d, and the power consumption processing unit 103b provided in the EMS 103. The power consumption processing unit 103b analyzes perturbation in the first total perturbated power consumption and calculates the total power consumption or the estimation value of the average of the total power consumption, using the first total perturbated power consumption calculated by the perturbated power processing unit 101c, the number n stored in the number storage unit 103c, and the random number generation parameters stored in the random number generation parameter storage unit 103d.

The structures according to the above-described embodiments can be applied to calculate the amount of gas or waster used, in addition to the calculation of power consumption.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server to which a plurality of power meters each measuring an amount of power consumption of an electric appliance is connected, comprising:
a receiving unit configured to receive a calculation result, the calculation result being calculated based on the amount of power consumption measured by each of the plurality of power meters and each of random numbers generated according to a probability distribution by each of the plurality of power meters;
a first storage unit configured to store therein parameters for generating random numbers;
a calculating unit configured to calculate an estimation value of a sum or average of the amounts of power consumption using the calculation results and the parameters, the estimation value being used for determining whether to perform power control.

2. The server according to claim 1, further comprising a second storage unit configured to store the number of the amounts of power consumption to be used for calculating the calculation result, wherein
the calculating unit calculates the estimation value of the sum or average of the amounts of power consumption using the calculation results, the parameters, and the number.

3. The server according to claim 2, wherein
the power meter generates the random numbers and obtains the calculation results using the random numbers and the amounts of power consumption, and
the server further comprises:
a generating unit configured to generate parameters for generating random numbers according to the probability distribution;
a changing unit configured to change the parameters stored in the first storage unit to the parameters generated by the generating unit; and
a transmitting unit configured to transmit the parameters to the power meter.

4. The server according to claim 3, wherein
The server is connected to a home server that controls the electric appliance, and
the transmitting unit transmits a command to control power consumption of the electric appliance to the home server according to a determination result as to whether to perform the power control.

5. A charging server to which a plurality of power meters each measuring an amount of power consumption of an electric appliance is connected, comprising:
a receiving unit configured to receive a sum of calculation results, the calculation result being calculated based on amounts of power consumption measured by a power meter and random numbers calculated according to a probability distribution by the power meter;
an acquiring unit configured to acquire a sum of the random numbers that have been used for calculation for the amounts of power consumption;
a calculating unit configured to calculate a sum of the amounts of power consumption measured by the power meter using the sum of the calculation results and the sum of the random numbers; and
a charging unit configured to perform a charging process using the sum of the amounts of power consumption.

6. The charging server according to claim 5, further comprising a first storage unit configured to store therein a unit cost used for the charging process for each predetermined classification, wherein
the receiving unit receives the sum of the calculation results for each classification,
the acquiring unit acquires the sum of the random numbers for the each classification,
the calculating unit calculates the sum of the amounts of power consumption for the each classification using the sum of the calculation results for the each classification and the sum of the random numbers for the each classification, and
the charging unit performs the charging process with reference to the unit cost for each classification which is stored in the first storage unit, using the sum of the amounts of power consumption for each classification.

7. A power consumption calculating system comprising:
a data management apparatus to which a plurality of power meters each measuring an amount of power consumption of an electric appliance is connected; and
an energy management apparatus connected to the data management apparatus, wherein
the data management apparatus includes:
a first receiving unit configured to receive a calculation result, the calculation result being calculated based on the amount of power consumption measured by each of the plurality of power meters and each of random numbers generated according to a probability distribution by each of the plurality of power meters;
a first calculating unit configured to calculate a sum or average of the calculation results; and
a transmitting unit configured to transmit the sum or average of the calculation results to the energy management apparatus, and
the energy management apparatus includes:
a second receiving unit configured to receive the sum or average of the calculation results;
a first storage unit configured to store therein parameters for generating random numbers;
a second calculating unit configured to calculate an estimation value of a sum or average of the amounts of power consumption measured by the plurality of power meters using the sum or average of the calculation results and the parameters; and
a determining unit configured to determine, on a basis of the estimation value, whether to perform power control.

8. A computer program product comprising a computer readable medium including programmed instructions, wherein the instructions, when executed by a computer to which a plurality of power meters each measuring an amount of power consumption of an electric appliance is connected, cause the computer to perform:
receiving a calculation result, the calculation result being calculated based on the amount of power consumption measured by each of the plurality of power meters and each of random numbers generated according to a probability distribution by each of the plurality of power;
calculating an estimation value of a sum or average of the amounts of power consumption using the calculation results and parameters for generating random number, the estimation value being used for determining whether to perform power control.

9. A computer program product comprising a computer readable medium including programmed instructions, wherein the instructions, when executed by a computer to which a power meter measuring an amount of power consumption of an electric appliance is connected to, cause the computer to perform:
receiving a sum of calculation results, the calculation result being calculated based on amounts of power consumption measured by the power meter and random numbers generated according to a probability distribution by the power meter;
acquiring a sum of the random numbers that have been used for calculation for the amounts of power consumption;
calculating a sum of the amounts of power consumption measured by the power meter using the sum of the calculation results and the sum of the random numbers; and
performing a charging process using the sum of the amounts of power consumption.
